(19) United States
(12) Patent Application Publication
(10) Pub. No.: US 2017/0084082 A1
(43) Pub. Date: Mar. 23, 2017

(54) SYSTEMS AND METHODS FOR PROVIDING AN AUGMENTED REALITY EXPERIENCE

(71) Applicant: HuntAR Corporation, Tempe, AZ (US)

(72) Inventors: Ryan McTaggart, Tempe, AZ (US); Alexander Hoftman, Tempe, AZ (US)

(73) Assignee: HuntAR Corporation, Tempe, AZ (US)

(21) Appl. No.: 15/267,774

(22) Filed: Sep. 16, 2016

Related U.S. Application Data
(60) Provisional application No. 62/220,182, filed on Sep. 17, 2015.

(51) Int. Cl. G06T 19/00; G06K 7/10

(52) U.S. Cl. CPC G06T 19/006; G06K 7/10861; G06T 2200/16; G06F 3/016

(57) ABSTRACT

A method of providing an augmented reality experience to a user device includes receiving, by a remote server, a unique identifier indicative of the augmented reality experience from the user device; acquiring, by the remote server, an experience file including at least one of the augmented reality experience, a geofence, and an age threshold for the augmented reality experience based on the unique identifier; and providing, by the remote server over a content delivery network, the augmented reality experience to the user device for display on a user interface of the user device.

### CROSS-REFERENCE TO RELATED PATENT APPLICATIONS

This application claims the benefit of U.S. Provisional Patent Application No. 62/220,182, filed Sep. 17, 2015, which is incorporated herein by reference in its entirety.

### BACKGROUND

Augmented reality systems provide an end user with the ability to scan an object and receive an augmented reality experience in return from content uploaded by clients of the augmented reality systems. Typically, the objects include a barcode or a quick response code. Further, the content being uploaded to augmented reality systems is not monitored for brand protection purposes for the clients and age appropriate content for end users.

### SUMMARY

One exemplary embodiment relates to a method of providing an augmented reality experience to a user device. The method includes receiving, by a remote server, a unique identifier indicative of the augmented reality experience from the user device; acquiring, by the remote server, an experience file including at least one of the augmented reality experience, a geofence for the augmented reality experience, and an age threshold for the augmented reality experience based on the unique identifier; and providing, by the remote server over a content delivery network, the augmented reality experience to the user device for display on a user interface of the user device.

Another exemplary embodiment relates to a method of creating an augmented reality experience for display on a user device. The method includes receiving, by a remote server, a target file for a target from a client device, the target file including an image of the target; determining, by the remote server, at least one of the client device is a trusted device and a similar target file does not already exist; acquiring, by the remote server, a unique identifier from a target recognition system for the target of the target file in response to a similar target file not existing or a similar target file existing but the client device is a trusted device; receiving, by the remote server, an experience file including the augmented reality experience for the target from the client device; and storing, by the remote server, the experience file and the unique identifier associated with the target on a database.

Yet another exemplary embodiment relates to a method for providing a video augmented reality experience onto a texture of a target from a remote server. The method includes providing, by a remote server via a content delivery network, an experience file including a video to a user device; loading, by an experience module on the user device associated with the remote server, each frame of the video on an frame-by-frame basis; and rendering, by the experience module for display to a user of the user device, each frame of the video onto the texture of the target such that each subsequent frame is over-laid over the prior frame to provide a representation of the video on the texture.

Still another exemplary embodiment relates to a method for providing a video augmented reality experience onto a texture of a target from a remote server. The method includes loading, by the remote server, a frame from a video of the video augmented reality experience; acquiring, by the remote server, pixel data from the frame of the video; copying, by the remote server, the pixel data to the texture of the target; and providing, by the remote server, a command to a user device to render the frame of the video onto the texture of the target. According to an exemplary embodiment, this process is advantageous for videos that are not stored locally on the user device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is schematic block diagram of an augmented reality system coupled to a client device, according to an exemplary embodiment.

FIG. 1B is schematic block diagram of an augmented reality system coupled to a user device, according to an exemplary embodiment.

FIG. 2A is a schematic block diagram of a remote server of the augmented reality system of FIGS. 1A-1B, according to an exemplary embodiment.

FIG. 2B is an illustration of a backend graphical user interface of the remote server in an experience search mode, according to an exemplary embodiment.

FIG. 2C is an illustration of a backend graphical user interface of the remote server in a detailed experience viewing mode, according to an exemplary embodiment.

FIG. 3A is a schematic block diagram of the client device of FIG. 1A, according to an exemplary embodiment.

FIG. 3B is an illustration of a graphical user interface of the client device in a target upload mode, according to an exemplary embodiment.

FIG. 3C is an illustration of a graphical user interface of the client device in an experience upload mode, according to an exemplary embodiment.

FIG. 4A is a schematic block diagram of the user device of FIG. 1B, according to an exemplary embodiment.

FIG. 4B is an illustration of a graphical user interface of the user device in a target scanning mode, according to an exemplary embodiment.

FIG. 4C is an illustration of a graphical user interface of the user device in an augmented reality experience display mode, according to an exemplary embodiment.

FIG. 4D is an illustration of a graphical user interface of the user device in a target scanning mode, according to another exemplary embodiment.

FIG. 4E is an illustration of a graphical user interface of the user device in an augmented reality experience display mode, according to another exemplary embodiment.

FIG. 5 is a flow diagram of a method for uploading a target file for a target to a remote server, according to an exemplary embodiment.

FIG. 6 is a flow diagram of a method for uploading an experience file associated with a target to a remote server, according to an exemplary embodiment.

FIG. 7 is a flow diagram of a method for validating an augmented reality experience, according to an exemplary embodiment.

FIG. 8 is a flow diagram of a method for creating a geofence, according to an exemplary embodiment.

FIG. 9 is a flow diagram of a method for executing an augmented reality experience based on a target scanned with a user device, according to an exemplary embodiment.

FIG. 10 is a flow diagram of a method of performing an age gate procedure, according to an exemplary embodiment.

FIG. 11 is a flow diagram of a method for verifying permissions to display an augmented reality experience on a user device, according to an exemplary embodiment.

FIG. 12 is a flow diagram of a method for providing a video AR experience onto a texture of a target from a remote server, according to an exemplary embodiment.

### DETAILED DESCRIPTION

Following below are more detailed descriptions of various concepts related to, and implementations of, methods, apparatuses, and systems for providing an augmented reality experience. The various concepts introduced above and discussed in greater detail below may be implemented in any of numerous ways, as the described concepts are not limited to any particular manner of implementation. Examples of specific implementations and applications are provided primarily for illustrative purposes. It should also be understood that the terminology is for the purpose of description only and should not be regarded as limiting.

According to an exemplary embodiment, an augmented reality (AR) system is configured to facilitate the display of an AR experience on a user device. As a brief overview, the AR system is configured to receive a target file (e.g., a two-dimensional image file, etc.) associated with a target of the AR experience. The AR system is further configured to receive an experience file associated with the target of the AR experience. A user device (e.g., cell phone, smartphone, tablet, smartwatch, laptop, computer, etc.) may be used to scan (e.g., with a camera device, etc.) the target associated with the AR experience. The AR system is configured to receive the scan of the target and provide the associated experience file to the user device such that the AR experience for the scanned target may be displayed to the user. Advantageously, the AR experience is provided to the user device without the need for the user device to scan a barcode or a quick response (QR) code, a user selecting or typing a uniform resource locator (URL), and/or the like.

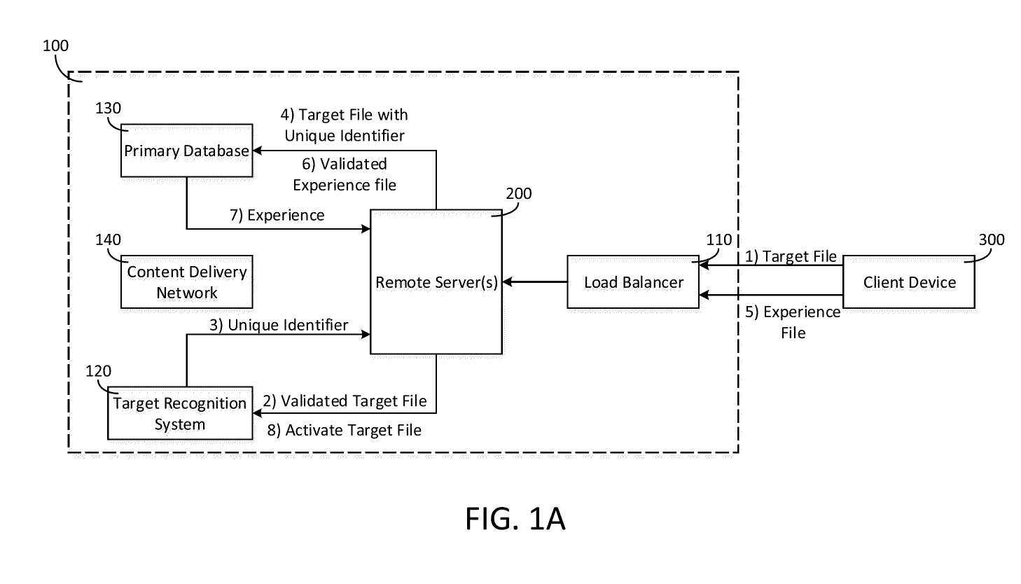

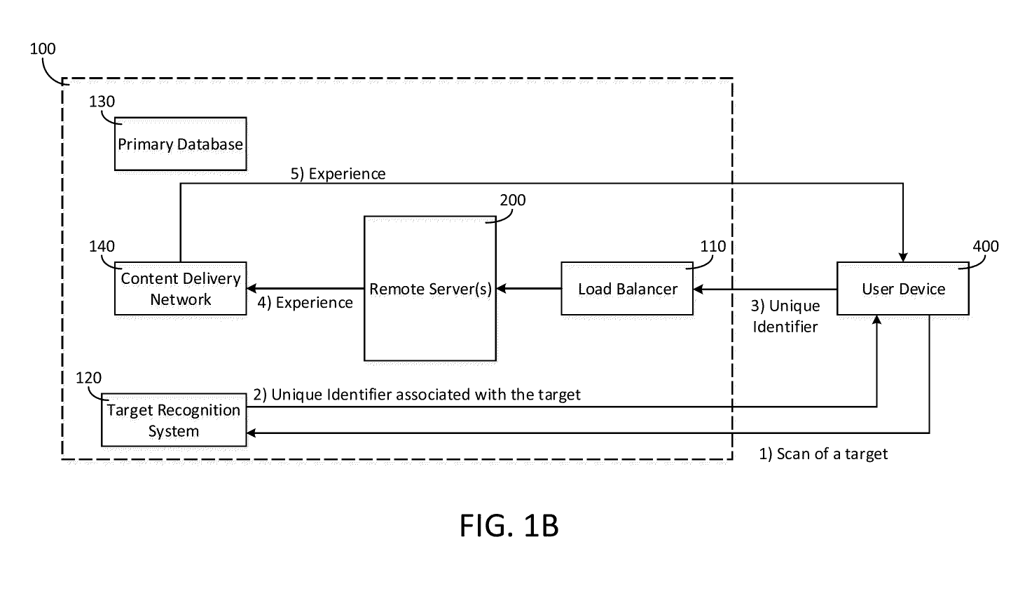

According to the exemplary embodiment shown in FIGS. 1-4E, an augmented reality system, shown as AR system 100, is selectively communicably coupled to a first device, shown as client device 300, and/or a second device, shown as user device 400. The AR system 100 is configured to receive an AR experience associated with a target from the client device 300. According to an exemplary embodiment, the AR experience includes a target file and an experience file. The target file may include a two-dimensional (2D) image (e.g., .PNG, .JPG, .GIF, etc.) of a logo, an insignia, a symbol, a text, and/or a combination thereof for a target. The target may be a physical object/item (e.g., an advertisement, a poster, a can, a bottle, a package, a sign, a text, a logo, etc.) or virtual (e.g., a virtual representation of the physical object/item on a television screen, on a computer monitor, as a hologram, etc.). The experience file may include a 2D image, a three-dimensional (3D) image, a 2D animation, a 3D animation, game logic/objects, a video, a video applied to a texture (e.g., on and/or around the target, etc.), a URL to a video, text, music, tactile feedback (e.g., vibrations, etc.), interactive content, and/or a combination thereof. The AR system 100 is further configured to provide the experience file to the user device 400 in response to the user device 400 scanning the associated target such that the AR experience may be displayed to the user. In some embodiments, the display of the AR experience is based on an age of the user, the location of the user device 400, and/or the platform the user device 400 operates on (e.g., Apple iOS, Android™, Windows®, etc.).

As shown in FIGS. 1A-1B, the AR system 100 includes a load balancer 110, a target recognition system 120 (e.g., Qualcomm® Vuforia™, etc.), a primary database 130, a content delivery network (CDN) 140 (e.g., LimeLight, etc.), and one or more remote servers 200. As shown in FIG. 1A, the AR system 100 is communicably coupled to the client device 300. In some embodiments, the AR system 100 is communicably coupled to a plurality of client devices 300 simultaneously. As shown in FIG. 1B, the AR system 100 is communicably coupled to the user device 400. In some embodiments, the AR system 100 is communicably coupled to a plurality of user devices 400 simultaneously. In some embodiments, the AR system 100 is coupled to one or more client devices 300 and one or more user devices 400 simultaneously.

Referring to FIG. 1A, a brief overview of the interaction between the client device 300 and the AR system 100 is shown. The load balancer 110 is configured to receive a target file for an AR experience from the client device 300. According to an exemplary embodiment, the load balancer 110 is configured to route requests to one of the one or more remote servers 200 with the fewest number of requests. Thus, the load balancer 110 is configured to direct the target file to a remote server 200 with the least requests (e.g., to increase efficiency, to evenly distribute the load between each of the remote servers 200, etc.). In some embodiments, the load balancer 110 is omitted. The remote server 200 is configured to validate the target file, according to an exemplary embodiment. The validation of the target file may include the remote server 200 determining that at least one of (i) the target file includes an image file (e.g., a 2D image file, .JPG, .PNG, etc.) and (ii) a similar target file does not already exist (e.g., a similar target file has not been already uploaded, etc.) or a similar target file does exists but the client is trusted (e.g., a registered client with an account with the AR system 100, etc.). The remote server 200 is further configured to send the validated target file to the target recognition system 120 for further processing.

The target recognition system 120 is configured to provide a universally unique identifier (UUID) to the remote server 200 for the target file and store the target file for future use. In one embodiment, the UUID is a string of 32 hexadecimal digits. The UUID may be created such that no two UUIDs are the same (e.g., regardless of whether the UUIDs are created by the same machine, etc.). According to an exemplary embodiment, the target file is deactivated within the target recognition system 120 while the AR experience is in processing (e.g., while the AR experience does not have an experience file associated with the target file, etc.). In some embodiments, the AR experience is locked while the target file is being processed by the target recognition system 120. The remote server 200 is configured to receive the UUID for the target file from the target recognition system 120 and associate the UUID with the target file of the AR experience. The remote server 200 is further configured to store the target file with the UUID for the AR experience in the primary database 130.

The load balancer 110 is further configured to receive an experience file associated with the target file for the AR experience from the client device 300. In one embodiment, the load balancer 110 is configured to direct the experience file to a remote server 200 with the least requests. In other embodiments, the load balancer 110 is configured to direct the experience file to the remote server 200 that received the associated target file. The remote server 200 is configured to validate the experience file, according to an exemplary embodiment. The validation of the experience file may include the remote server 200 determining whether at least one of (i) the experience file is in the required format (e.g., a video file for a video experience, etc.), (ii) the AR experience is unlocked (e.g., whether the associated target file is still being processed by the target recognition system 120, etc.), and (iii) the experience file is compatible across various platforms (e.g., Apple iOS, Android™, Windows®, etc.).

The remote server 200 is configured to send the validated experience file to the primary database 130 for storage with the target file and the UUID (e.g., to form a completed AR experience, etc.). According to an exemplary embodiment, the remote server 200 is configured to delete the local copy of the experience file and/or the target file relating to the AR experience. The remote server 200 may be further configured to receive a read-only copy of the AR experience from the primary database 130. Thus, edits or deletions to AR experiences are sent through the remote server 200 to the primary database 130, and then propagated through all the remote servers 200 to the read-only copy of the AR experiences. According to an exemplary embodiment, storing read-only copies of AR experiences reduces the amount of time it takes to provide the AR experience to a user when a target is scanned by a user device 400. Once the AR experience meets all the requirements (e.g., has both a valid target file and a valid experience file, etc.), the remote server 200 is configured to provide a command to the target recognition system 120 to activate the target file of the AR experience such that the AR experience becomes live (e.g., a user is able to receive the AR experience by scanning a target associated with the activated target file, etc.). In some embodiments, the remote server 200 is configured to send the validated AR experiences to the CDN 140 for storage. According to an exemplary embodiment, the CDN 140 is configured to send (e.g., push, etc.) AR experiences to the user devices 400.

Referring to FIG. 1B, a brief overview of the interaction between the user device 400 and the AR system 100 is shown. The target recognition system 120 is configured to receive a scan of a potential target from the user device 400. According to an exemplary embodiment, the scan of the potential target is captured with a camera device of the user device 400. The target recognition system 120 is configured to determine whether the potential target matches a target of an activated target file. The target recognition system 120 is further configured to send a UUID associated with the scanned target to the user device 400 in response to the scanned target matching the target of an activated target file. The load balancer 110 is configured to receive the UUID for the scanned target from the user device 400, which is then routed to one of the remote servers 200 (e.g., the remote server 200 with the fewest requests, etc.).

The remote server 200 is configured to use the UUID to acquire the experience file associated with the UUID stored locally on the remote server 200 (e.g., the read-only copy of the AR experience, etc.). In some embodiments, acquiring the experience file is further based on the platform of the user device 400 and/or the location of the user device 400 (e.g., geolocation, etc.). In some embodiments, the remote server 200 is configured to determine whether the AR experience requested is age appropriate for the user of the user device 400 (e.g., via an age threshold associated with the experience file, etc.). The remote server 200 is then configured to load the experience onto the CDN 140 and/or provide a command to the CDN 140 to execute the AR experience on (e.g., push the AR experience to, etc.) the user device 400. The AR experience may thereby be provided on a display of the user device 400.

In one embodiment, the AR experience is displayed over the target. In some embodiments, the AR experience is displayed on a surface of the target (e.g., around a bottle/can, along a surface of the target, etc.). In some embodiments, the AR experience is displayed in a new window (e.g., the user device 400 opens a YouTube® video, etc.). In some embodiments, the remote server 200 is further configured to verify that the user device 400 has permission to access the content of the remote server 200 before executing the AR experience. If the user device 400 does not, the remote server 200 is configured to remotely disable the user device 400 (i.e., prevent the AR experience from being displayed).

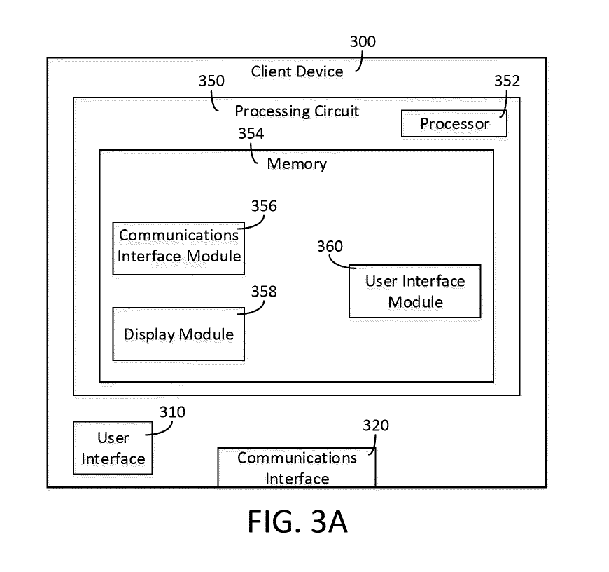

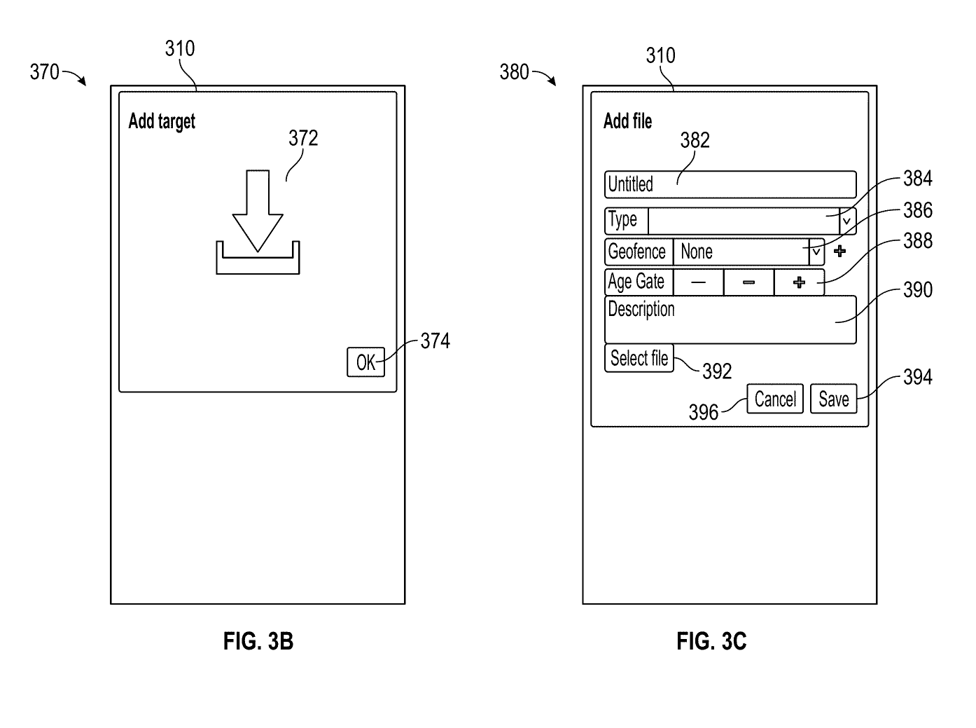

Referring to FIG. 3A, the client device 300 includes a user interface 310, a communications interface 320, and a processing circuit 350. In one embodiment, the client device 300 is structured as a portable device. The portable device may include, but is not limited to, a smartphone, a tablet, a laptop, a smart watch, and/or any other type of form factor device. In some embodiments, the client device 300 is structured as a stationary device (e.g., a desktop computer, etc.). The user interface 310 may include a display screen, a touch screen, one or more buttons, a touch pad, a mouse, and/or other devices to allow a client to operate the client device 300. According to an exemplary embodiment, the user interface 310 is configured to provide a display to the client using the client device 300. In one embodiment, the display of the user interface 310 provides an account login interface. The account login interface may be configured to provide a client of the AR system 100 with the ability to sign-up for an account associated with the AR system 100 (e.g., a new client, etc.), access an existing account associated with the AR system 100 (e.g., with client credentials such as a username, account ID, email, password, etc.), and/or delete an existing account associated with the AR system 100. In another embodiment, the display of the user interface 310 provides a client account interface. The client account interface may be configured to provide a client of the AR system 100 with the ability to update/change credentials and/or account settings, among other possibilities. In still another embodiment, the display of the user interface 310 provides a target interface. The target interface may be configured to provide a client of the AR system 100 with the ability to upload, delete, and/or edit target files for a target. In yet another embodiment, the display of the user interface 310 provides an experience interface. The experience interface may be configured to provide a client of the AR system 100 with the ability to upload, delete, and/or edit experience files for a target.

Referring still to FIG. 3A, the communications interface 320 may be configured to facilitate the communication between the client device 300 and the AR system 100 (e.g., the load balancer 110, the remote server 200, etc.). The communication may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, Bluetooth, Zigbee, etc. In one embodiment, a controller area network (CAN) bus provides the exchange of signals, information, and/or data. The CAN bus includes any number of wired and wireless connections.

As shown in FIG. 3A, the processing circuit 350 includes a processor 352 and a memory 354. The processor 352 may be implemented as a general-purpose processor, an application specific integrated circuit (ASIC), one or more field programmable gate arrays (FPGAs), a digital signal processor (DSP), a group of processing components, or other suitable electronic processing components. One or more memory devices 354 (e.g., RAM, ROM, Flash Memory, hard disk storage, etc.) may store data and/or computer code for facilitating the various processes described herein. Thus, the one or more memory devices 354 may be communicably connected to the processor 352 and provide computer code or instructions to the processor 352 for executing the processes described in regard to the client device 300 herein. Moreover, the one or more memory devices 354 may be or include tangible, non-transient volatile memory or non-volatile memory. In some embodiments, the one or more memory devices 354 may include database components, object code components, script components, or any other type of information structure for supporting the various activities and information structures described herein.

The memory 354 is shown to include various modules for completing processes described herein. More particularly, the memory 354 includes modules configured to facilitate transferring target files and/or experience files to the remote server 200 such that the remote server 200 may store an AR experience for a target (e.g., which may be provided to a user device 400, etc.). While various modules with particular functionality are shown in FIG. 3A, it should be understood that the client device 300 and the memory 354 may include any number of modules for completing the functions described herein. For example, the activities of multiple modules may be combined as a single module and additional modules with additional functionality may be included. Further, it should be understood that the processing circuit 350 of the client device 300 may further control other processes beyond the scope of the present disclosure.

As shown in FIG. 3A, the client device 300 includes a communications interface module 356, a display module 358, and a user interface module 360. The communications interface module 356 may be communicably coupled to the communications interface 320 and configured to control the communication (e.g., the transfer of information, etc.) between the client device 300 and the AR system 100 (e.g., the load balancer 110, the remote server(s) 200, etc.). The display module 358 is configured to provide a display on the user interface 310 (e.g., a monitor, a touchscreen, display screen, etc.) of the client device 300. The display module 358 is further configured to provide the display regarding various user interfaces (e.g., an account login interface, a client account interface, a target interface, an experience interface, etc.) corresponding with the AR system 100. The display module 358 may also be configured to display various other features and/or user interfaces not related to the present disclosure.

The user interface module 360 may be configured to receive an input from a user of the client device 300 via the user interface 310 (e.g., touchscreen inputs, button inputs, etc.). The input may include a command to operate the client device 300 (e.g., turn on, turn off, select a feature, etc.). The input may also include a command to open an application interface (e.g., a smartphone application, a tablet application, etc.) or website interface (e.g., a website, URL, etc.) associated with the AR system 100. The input may also include a command to be directed to a chosen user interface. Thus, the user interface module 360 may be configured to instruct the display module 358 which user interface to display to the user of the client device 300 based on the inputs. For example, a client may select to open an application or website associated with the AR system 100. Therefore, the user interface module 360 may provide instructions to the display module 358 to display an account login interface on a display of the user interface 310 such that the client may provide client credentials to log into the AR system 100 via the client device 300.

A client of AR system 100 may be further provided a target interface and/or an experience interface by the display module 358 responsive to the user interface module 360 receiving a command regarding a target file and/or an experience file of an AR experience via the client device 300. The client may then upload, edit, and/or delete a target file using the target interface and/or an experience file using the experience interface. The display module 358 may also be configured to receive a command from the remote server 200 to display certain user interfaces to a client of the AR system 100 (e.g., error messages, notifications, etc.).

Referring now to FIG. 3B, the display module 358 may provide a target interface 370 on the user interface 310 of the client device 300 in response to a client selecting to upload, edit, or delete a target file. As shown in FIG. 3B, the target interface 370 includes an insertion slot 372 to insert a desired target file. The target file may be dragged and dropped by a client into the insertion slot 372 (e.g., from a folder, a desktop, a cloud storage location, etc.), a client may click the insertion slot 372 to browse the memory 354 of the client device 300 or memory device externally coupled to the client device 300 to select a desired target file to upload, or the target file may be otherwise selected. Once the desired target file is selected, the client may select the button 374 to confirm the upload (or edit/deletion) thereby facilitating the transmission of the target file to the AR system 100.

Referring now to FIG. 3C, the display module 358 may provide an experience interface 380 on the user interface 310 of the client device 300 in response to a client selecting to upload, edit, or delete an experience file. As shown in FIG. 3C, the experience interface 380 may allow a client to enter/select a plurality of configurable options for an experience file. The configurable options may include a title of the experience file, a type of experience file, a geofence for the experience file, an age gate (i.e., an age threshold) for the experience file, and/or a description for the experience file. As shown in FIG. 3C, the experience interface 380 includes a title slot 382, a type slot 384, a geofence slot 386, an age gate slot 388, a description slot 390, a select file button 392, a save button 394, and a cancel button 396. The title slot 382 is configured to facilitate entering a title for an experience file. The type slot 384 is configured to facilitate selecting a type of an experience file (e.g., a 2D image, a 3D image, a 2D animation, a 3D animation, game logic/objects, a video, a video applied to a texture, a URL to a video, text, music, tactile feedback, interactive content, etc.). The geofence slot 386 is configured to facilitate entering information (e.g., a radius, an address, etc.) regarding a geofence for an experience file. The age gate slot 388 is configured to facilitate entering an age threshold (e.g., 17 years old, 18 years old, 21 years old, etc.) for an experience file. The description slot 390 is configured to facilitate entering a description of an experience file. The select file button 392 is configured to facilitate selecting an experience file to upload, edit, or delete to/from the AR system 100. The save button 394 is configured to facilitate accepting all of the configurable options and transmitting the request to the AR system 100. The cancel button 396 is configured to facilitate exiting the experience interface 380.

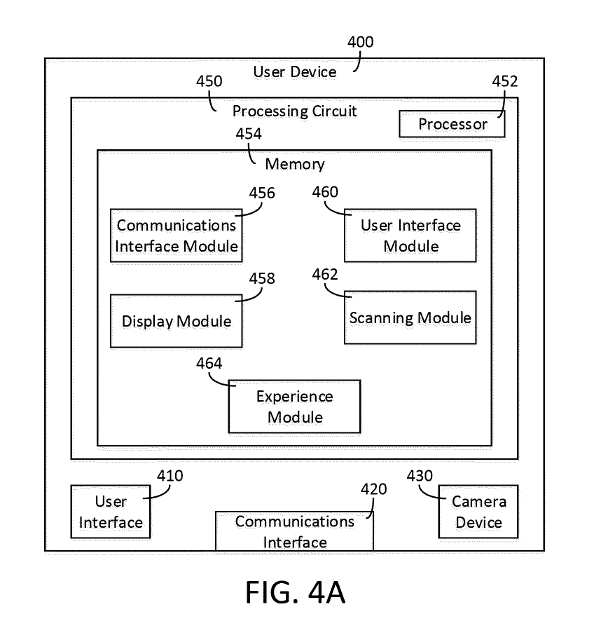

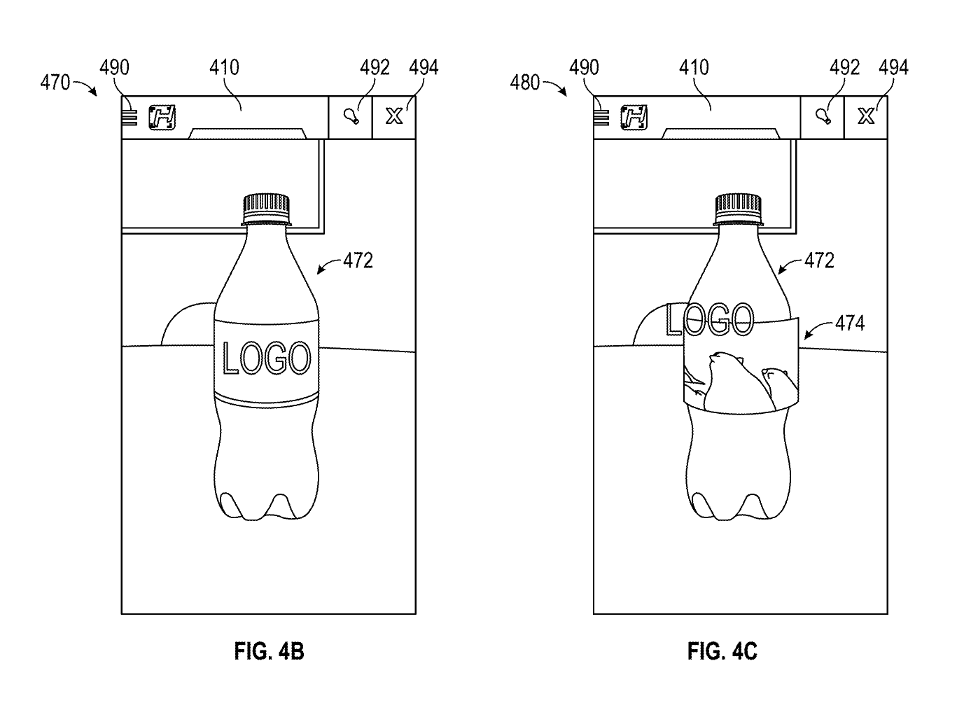

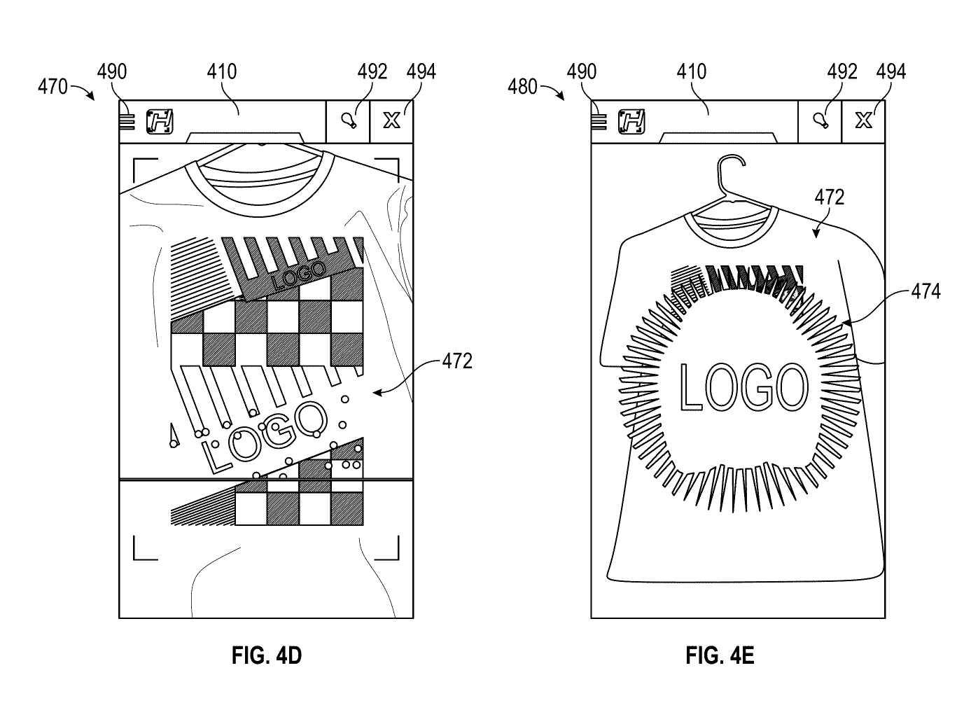

Referring to FIG. 4A, the user device 400 includes a user interface 410, a communications interface 420, a camera device 430, and a processing circuit 450. In one embodiment, the user device 400 is structured as a portable device. The portable device may include, but is not limited to, a smartphone, a tablet, a laptop, a smart watch, and/or any other type of form factor device. In some embodiments, the user device 400 is structured as a stationary device (e.g., a desktop computer, etc.). The user interface 410 may include a display screen, a touch screen, one or more buttons, a touch pad, a mouse, and/or other devices to allow a user to operate the user device 400. According to an exemplary embodiment, the user interface 410 is configured to provide a display to the user of the user device 400. In one embodiment, the display of the user interface 410 provides an account login interface. The account login interface may be configured to provide a user of the AR system 100 with the ability to sign-up for an account associated with the AR system 100 (e.g., a new user, etc.), access an existing account associated with the AR system 100 (e.g., with user credentials such as a username, account ID, email, password, etc.), and/or delete an existing account associated with the AR system 100. In another embodiment, the display of the user interface 410 provides a user account interface. The user account interface may be configured to provide a user of the AR system 100 with the ability to update/change credentials, among other possibilities. In still another embodiment, the display of the user interface 410 provides a target scanning interface. The target scanning interface may be configured to provide a user of the AR system 100 with the ability to view and scan a target that is in the view of the camera device 430 of the user device 400. In yet another embodiment, the display of the user interface 410 provides an AR experience interface. The AR experience interface may be configured to provide a user of the AR system 100 with a display of an AR experience based on a scanned target.

Referring still to FIG. 4A, the communications interface 420 may be configured to facilitate the communication between the user device 400 and the AR system 100 (e.g., the load balancer 110, the target recognition system 120, the remote server 200, the CDN 140, etc.). The communication may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, Bluetooth, Zigbee, etc. In one embodiment, a controller area network (CAN) bus provides the exchange of signals, information, and/or data. The CAN bus includes any number of wired and wireless connections.

As shown in FIG. 4A, the processing circuit 450 includes a processor 452 and a memory 454. The processor 452 may be implemented as a general-purpose processor, an application specific integrated circuit (ASIC), one or more field programmable gate arrays (FPGAs), a digital signal processor (DSP), a group of processing components, or other suitable electronic processing components. One or more memory devices 454 (e.g., RAM, ROM, Flash Memory, hard disk storage, etc.) may store data and/or computer code for facilitating the various processes described herein. Thus, the one or more memory devices 454 may be communicably connected to the processor 452 and provide computer code or instructions to the processor 452 for executing the processes described in regard to the user device 400 herein. Moreover, the one or more memory devices 454 may be or include tangible, non-transient volatile memory or non-volatile memory. In some embodiments, the one or more memory devices 454 may include database components, object code components, script components, or any other type of information structure for supporting the various activities and information structures described herein.

The memory 454 is shown to include various modules for completing processes described herein. More particularly, the memory 454 includes modules configured to facilitate obtaining a UUID for a scanned target such that the remote server 200 may provide an AR experience associated with the scanned target to the user device 400. While various modules with particular functionality are shown in FIG. 4A, it should be understood that the user device 400 and the memory 454 may include any number of modules for completing the functions described herein. For example, the activities of multiple modules may be combined as a single module and additional modules with additional functionality may be included. Further, it should be understood that the processing circuit 450 of the user device 400 may further control other processes beyond the scope of the present disclosure.

As shown in FIG. 4A, the user device 400 includes a communications interface module 456, a display module 458, a user interface module 460, a scanning module 462, and an experience module 464. The communications interface module 456 may be communicably coupled to the communications interface 420 and configured to control the communication (e.g., the transfer of information, etc.) between the user device 400 and the AR system 100 (e.g., the load balancer 110, the remote server(s) 200, the target recognition system 120, the CDN 140, etc.). The display module 458 is configured to provide a display on the user interface 410 (e.g., a monitor, a touchscreen, display screen, etc.) of the user device 400. The display module 458 is further configured to provide the display regarding various user interfaces (e.g., an account login interface, a user account interface, a target scanning interface, an AR experience interface, etc.) corresponding with the AR system 100. The display module 458 may also be configured to display various other features and/or user interfaces not related to the present disclosure.

The user interface module 460 may be configured to receive an input from a user of the user device 400 via the user interface 410 (e.g., touchscreen inputs, button inputs, etc.). The input may include a command to operate the user device 400 (e.g., turn on, turn off, select a feature, etc.). The input may also include a command to open an application interface (e.g., a smartphone application, a tablet application, etc.) or website interface (e.g., a website, URL, etc.) associated with the AR system 100. The input may also include a command to be directed to a chosen user interface. Thus, the user interface module 460 may be configured to instruct the display module 458 which user interface to display to the user of the user device 400 based on the inputs. For example, a user may select to open an application or website associated with the AR system 100. Therefore, the user interface module 460 may provide instructions to the display module 458 to display an account login interface on a display of the user interface 410 such that the user may provide user credentials to log into the AR system 100 via the user device 400. A user of AR system 100 may be further provided a target scanning interface by the display module 458 responsive to the user interface module 460 receiving a command regarding scanning a target via the camera device 430 of the user device 400. The display module 458 may also be configured to receive a command from the remote server 200 to display an AR experience interface regarding an AR experience associated with the scanned target.

The scanning module 462 may be configured to control operation of the camera device 430 and/or receive a scan of a target from the camera device 430 of the user device 400. The scanning module 462 may be further configured to transmit the scan of the target to the communications interface module 456 such that the scan may be sent to the target recognition system 120. The user device 400 may then receive an associated UUID for the scanned target (e.g., if the scanned target matches an activated target within the target recognition system 120, etc.).

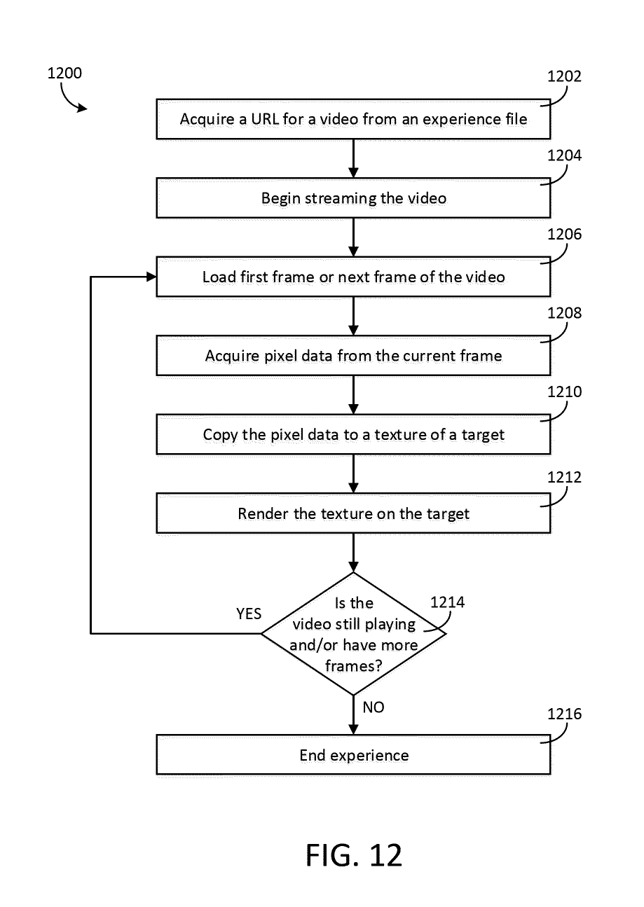

The experience module 464 may be configured to process an experience file received from the remote server 200 via the CDN 140. The experience module 464 may extract (e.g., load, etc.) an AR experience from the experience file such that the AR experience may be displayed on the user interface 410. In an alternative embodiment, the AR experience is delivered directly by the CDN 140 such that the experience module 464 is configured to receive the AR experience for display on the user interface 410 (e.g., the experience module 464 does not have to extract the AR experience from the experience file, etc.). In some embodiments, the experience module 464 facilitates the display of a video on a texture from the remote server 200. In one embodiment, the experience module 464 receives a command from the remote server 200 to render a video onto a texture on a frame-by-frame basis, where the remote server 200 performs all of the processing prior to each frame of the video being sent to the experience module 464. In other embodiments, the experience module 464 receives the experience file that includes the video from the remote server 200 via the CDN 140 and performs all of the processing to apply the video to a texture (see, e.g., FIG. 12). For example, the experience module 464 may be configured to receive a video file from the remote server 200. The experience module 464 may then load each frame of the video on a frame-by-frame basis. The experience module 464 may be further configured to render each frame of the video onto the texture of the target such that each subsequent frame is over-laid over the prior frame to provide a representation of the video on the texture.

Referring now to FIGS. 4B and 4D, the display module 458 may provide a target scanning interface 470 on the user interface 410 of the user device 400 in response to a user selecting a target 472 to scan. As shown in FIGS. 4B and 4D, the target scanning interface 470 is configured to provide a user of the user device 400 with the ability to view and scan a target with the camera device 430 of the user device 400. Referring now to FIGS. 4C and 4E, the display module 458 may provide an AR experience interface 480 on the user interface 410 of the user device 400 in response to the scanned target being associated with an experience file. As shown in FIGS. 4C and 4E, the AR experience interface 480 is configured to provide a user of the user device 400 with the ability to view an AR experience 474 on the user device 400. As shown in FIG. 4C, the AR experience 474 provided by the AR experience interface 480 is a video to texture experience where a video is applied (e.g., disposed, etc.) along the surface of the target 472 (e.g., a bottle, a cylinder, etc.). As shown in FIG. 4E, the AR experience 474 provided by the AR experience interface 480 is a 3D animation projected from the target 472 (e.g., a logo on a t-shirt, etc.). It should be noted that the targets 472 and AR experiences 474 of FIGS. 4B-4E are for illustrative purposes only and therefore should not be limiting. In other embodiments, various other targets 472 may be scanned and various other AR experiences 474 may be displayed by the user device 400.

As shown in FIGS. 4B-4E, the user interfaces of the user device 400 include a plurality of configurable options. The user interfaces include a menu button 490, a light button 492, and an exit button 494. The menu button 490 may facilitate selecting various options such as entering a scanning mode (e.g., the target scanning mode, etc.), accessing account settings (e.g., name, age, location, email address, info needed to enter sweepstakes, etc.), see which targets are active for scanning, etc. The light button 492 may facilitate turning on and off a light of the user device 400 (e.g., to illuminate a target in a dark setting, etc.). The exit button 494 may facilitate exiting the application or website associated with the AR system 100.

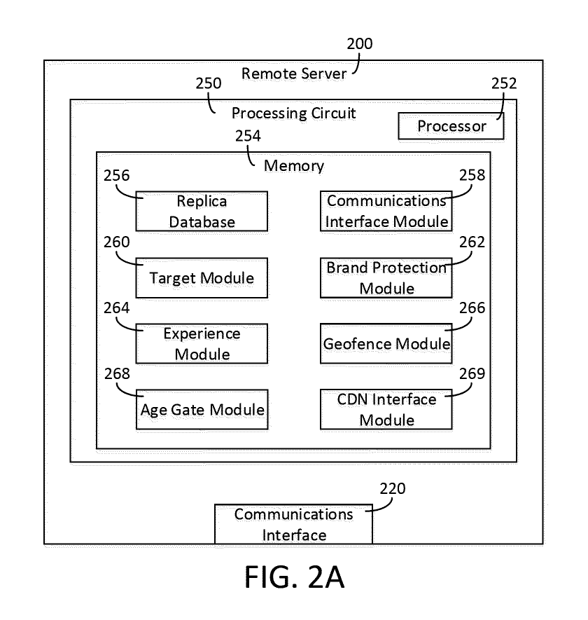

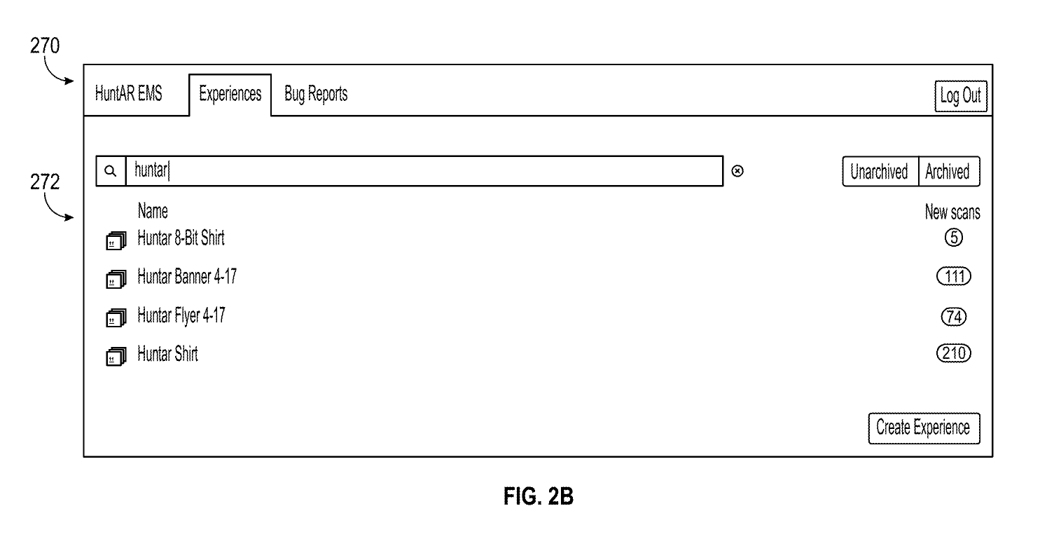

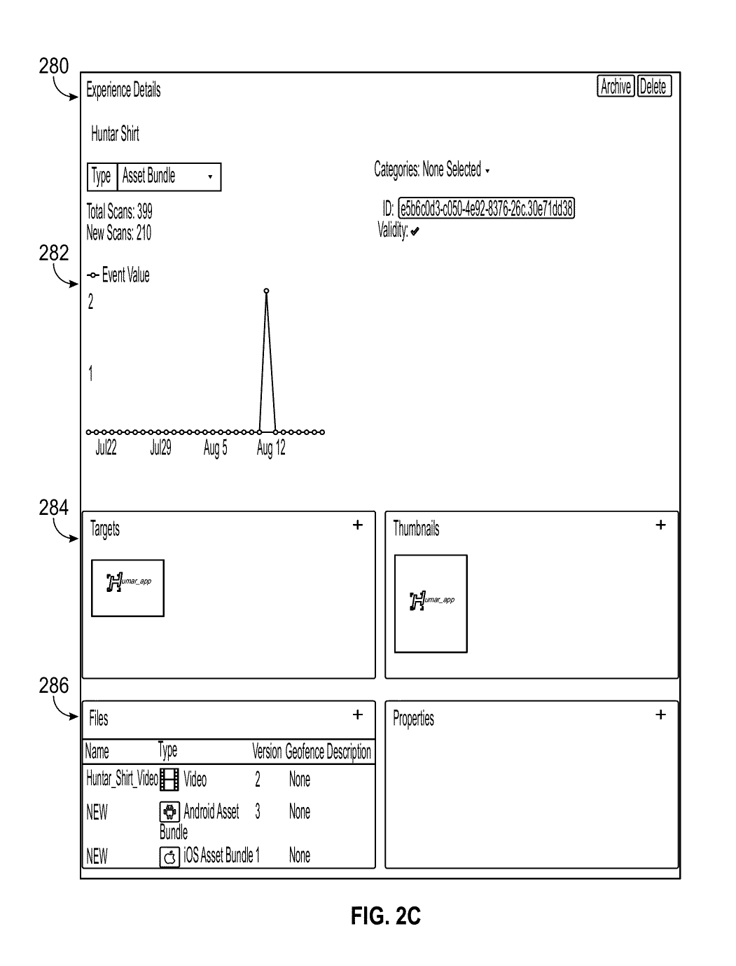

Referring now to FIG. 2A, the remote server 200 includes a communications interface 220 and a processing circuit 250. The communications interface 220 may be configured to facilitate the communication between one or more client devices 300, one or more user devices 400, the load balancer 110, the target recognition system 120, the primary database 130, the CDN 140, and the remote server(s) 200. The communication between the components of the remote server(s) 200, the other components of the AR system 100, the client device(s) 300, and the user device(s) 400 may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, Bluetooth, Zigbee, etc. In one embodiment, a controller area network (CAN) bus provides the exchange of signals, information, and/or data. The CAN bus includes any number of wired and wireless connections.

As shown in FIG. 2A, the processing circuit 250 includes a processor 252 and a memory 254. The processor 252 may be implemented as a general-purpose processor, an application specific integrated circuit (ASIC), one or more field programmable gate arrays (FPGAs), a digital signal processor (DSP), a group of processing components, or other suitable electronic processing components. One or more memory devices 254 (e.g., RAM, ROM, Flash Memory, hard disk storage, etc.) may store data and/or computer code for facilitating the various processes described herein. Thus, the one or more memory devices 254 may be communicably connected to the processor 252 and provide computer code or instructions to the processor 252 for executing the processes described in regard to the remote server 200 herein. Moreover, the one or more memory devices 254 may be or include tangible, non-transient volatile memory or non-volatile memory. In some embodiments, the one or more memory devices 254 may include database components, object code components, script components, or any other type of information structure for supporting the various activities and information structures described herein.

The memory 254 is shown to include various databases and modules for completing processes described herein. More particularly, the memory 254 includes databases and modules configured to receive various information from the client device(s) 300, the user device(s) 400, the primary database 130, and the target recognition system 120 and provide an AR experience to a user device 400 via the CDN 140 based on the various information. While various databases and modules with particular functionality are shown in FIG. 2A, it should be understood that the remote server 200 and the memory 254 may include any number of databases and/or modules for completing the functions described herein. For example, the activities of multiple databases and/or modules may be combined as a single database and/or module and additional databases and/or modules with additional functionality may be included. Further, it should be understood that the processing circuit 250 of the remote server 200 may further control other processes beyond the scope of the present disclosure.

As shown in FIG. 2A, the remote server 200 includes a replica database 256, a communications interface module 258, a target module 260, a brand protection module 262, an experience module 264, a geofence module 266, an age gate module 268, and a CDN interface module 269. The replica database 256 is configured to store copies of the AR experiences (e.g., the target files, the UUIDs, the experience files, etc.) uploaded by the client devices 300. According to an exemplary embodiment, each time an AR experience is uploaded, edited, or deleted to/from the primary database 130, the replica database 256 of each remote server 200 replicates the changes (e.g., the primary database 130 and the replica database(s) 256 are in sync, etc.). In one embodiment, the copies of the AR experiences stored within the replica database(s) 256 are read-only files. The communications interface module 258 may be communicably coupled to the communications interface 220 and configured to control the communication (e.g., the transfer of information, etc.) between the remote server(s) 200 and the client device(s) 300, the user device(s) 400, the load balancer 110, the target recognition system 120, the primary database 130, and the CDN 140.

The target module 260 is configured to receive a target file from the client device 300. In some embodiments, the target module 260 is further configured to validate the target file. The validation of the target file may include the target module 260 determining whether the target file includes an image file (e.g., a 2D image file, .JPG, .PNG, etc.). If the target file does not include an image file, the target module 260 may provide a notification on the client device 300 that the target file is invalid and deny the upload of the target file.

In some embodiments, the brand protection module 262 is configured to further validate the target file. In one embodiment, the brand protection module 262 is configured to compare the target file with previously uploaded target files stored in the primary database 130 and/or the replica database 256 to determine whether a similar target file exists. In some embodiments, the brand protection module 262 is configured to send the target file to the target recognition system 120 where the target recognition system 120 compares the target file to previously uploaded target files to determine whether a similar target file exists. The brand protection module 262 may be configured to notify a moderator of the AR system 100 (e.g., HuntAR Corp., Tagglar Inc., etc.) that a similar target file has been attempted to be uploaded (e.g., an alert, an email, etc.). Advantageously, this may allow the moderator to monitor and/or override any decisions made by the brand protection module 262 regarding similar target files being uploaded to the AR system 100.

The brand protection module 262 may be further configured to determine whether the client device 300 is a trusted device (e.g., the account the client is using on the client device 300 is verified/registered, etc.) in response to a similar target file existing. If the client device 300 is not trusted, the brand protection module 262 is configured to deny the upload of the target file and command the client device 300 to display an error message on the user interface 310 of the client device 300. Advantageously, this substantially prevents a client of the AR system 100 from creating an AR experience for a target (e.g., logo, product, etc.) that they are not affiliated with and/or own (e.g., Company X can only upload AR experiences for Company X related targets, etc.). If the client device 300 is trusted, the brand protection module 262 is configured to allow the upload of the target file to continue. For example, a client may have multiple targets with the same logo (e.g., on a t-shirt, a bottle, a poster, etc.) or variations of a logo (e.g., based on geographic location, etc.). Thus, this allows a client to upload multiple targets for an AR experience and/or multiple AR experiences for a target (e.g., based on a geofence, etc.).

The target module 260 is further configured to send the validated target file to the target recognition system 120 to be uploaded to the target recognition system 120 for further processing in response to at least one of the client device 300 being a trusted device and a similar target file not already existing. The target module 260 is further configured to receive a UUID for the target file from the target recognition system 120 and associate the UUID with the target file. The target module 260 may be configured to store the target file with the UUID for the AR experience in the primary database 130 (e.g., which may then be duplicated onto the replica database 256, etc.). In some embodiments, the target module 260 is configured to deactivate the target file while the AR experience is in processing (e.g., until an experience file is associated with the target file, etc.) and lock the AR experience while the target recognition system 120 is processing the target file. This may keep the data stored in both the target recognition system 120 and the primary database 130 consistent (e.g., prevents a client from editing a target file while the target file is being processed by the target recognition system 120, etc.). The target module 260 may activate the target file in response to the associated AR experience meeting all requirements (e.g., a target file and an experience file for an AR experience are validated and stored within the AR system 100, etc.).

The experience module 264 is configured to receive an experience file from the client device 300 associated with a target file and a UUID of an AR experience. According to an exemplary embodiment, the experience file includes metadata including at least one of a title, a type (e.g., a 2D image, a 3D image, a 2D animation, a 3D animation, game logic/objects, a video, a video applied to a texture, a URL to a video, text, music, tactile feedback, interactive content, etc.), a geofence (e.g., a radius and address, etc.), an age threshold, a description, and a version number of the experience file. In some embodiments, the experience module 264 is further configured to validate the experience file. The validation of the experience file may include the experience module 264 determining whether the experience file format matches the type selected by the client when the experience file was uploaded (e.g., a video file for a video type, etc.). The validation of the experience file may include the experience module 264 determining that the experience file is compatible across various platforms (e.g., Apple iOS, Android™, Windows®, etc.). For example, certain platforms may require platform specific experience files for certain experience types. If the experience file format does not match the selected type and/or the platform specific files are not included, the experience module 264 may provide a notification on the client device 300 that the experience file is invalid and deny the upload of the experience file.

The experience module 264 is further configured to determine whether the AR experience associated with the experience file is locked (e.g., the associated target file is still being processed by the target recognition system 120, etc.). If the AR experience is locked, the experience module 264 may provide a notification on the client device 300 that the AR experience is currently locked. If the AR experience in not locked, the experience module 264 may be configured to store the experience file with the UUID and the target file for the AR experience in the primary database 130 (e.g., which may then be duplicated onto the replica database 256, etc.). In some embodiments, the experience module 264 is configured to delete the local copy of the uploaded experience file after it is stored within the primary database 130.

The geofence module 266 is configured to receive geofence data including an address and a radius from the client. In some embodiments, the address and the radius are included within the experience file when uploaded by the client. In some embodiments, the geofence module 266 is configured to prompt a client to add a geofence to the experience file of the AR experience during the uploading process. According to an exemplary embodiment, the geofence module 266 is configured to acquire geographic coordinates for the address (e.g., latitude and longitude, from a web mapping service, etc.). The geofence module 266 is further configured to create a geofence for the experience file based on the geographic coordinates and the radius (e.g., creating an encircled area of a geographic location, etc.). In some embodiments, the geofence module 266 is configured to store the geofence for the experience file within the primary database 130 (e.g., which may then be duplicated onto the replica database 256, etc.). According to an exemplary embodiment, the geofence module 266 is configured to determine a current location of a user device 400 when the user device 400 transmits a UUID to the AR system 100 (e.g., to determine whether the user device 400 is within a geofence of an experience file, etc.).

The target module 260 is further configured to receive a UUID from a user device 400 (e.g., received from the target recognition system 120 based on a scanned target, etc.). In some embodiments, the target module 260 is configured to determine the platform the user device 400 is operating on. According to an exemplary embodiment, the experience module 264 is further configured to acquire an experience file from the replica database 256 based on the UUID of the scanned target, the platform of the user device 400, and/or the geolocation of the user device 400.

The age gate module 268 is configured to determine whether the acquired experience file has an age threshold and compare the age threshold to the user's age. In some embodiments, the age of the user is not known. Thus, the age gate module 268 is configured to send a command to the user device 400 to prompt the user to enter his/her age (e.g., birthdate, etc.) in response to the age of the user not being known when an age threshold is included in an acquired experience file. In other embodiments, the age of a user is determined when the user first connects to the AR system 100 with the user device 400 (e.g., sets up an account, prompted to enter age, etc.). In some embodiments, the age gate module 268 is configured to receive and store the user's age for future use (e.g., such that the user does not have to re-enter his/her birthday each time an AR experience has an age threshold, etc.).

With the user's age known, the age gate module 268 is configured to determine whether the user's age is greater than or equal to an age threshold of an experience file. If the user's age is greater than or equal to the age threshold or the experience file does not have an age threshold, the age gate module 268 is configured to allow the loading of an AR experience from the experience file. If the user's age is less than the age threshold, the age gate module 268 is configured to send a command to the user device 400 to display an error message to the user of the user device 400 (e.g., that the content is not age appropriate, etc.). By way of example, an AR experience related to an R-rated movie may have an age threshold of seventeen years old, an AR experience related to tobacco products may have an age threshold of eighteen years old, an AR experience related to alcoholic beverages may have an age threshold of twenty-one years old, etc. Following the age gate procedure, the communications interface module 258 may be configured to transmit the experience file to the CDN 140 such that the AR experience may be displayed to the user on the user device 400.

The CDN interface module 269 may be configured to transmit experience files to the CDN 140 for storage and/or in response to a target associated with the experience file being scanned by a user device 400 for delivery to the user device 400. The CDN interface module 269 may be configured also to control communication of the CDN 140 with the user devices 400. For example, the CDN interface module 269 may send a command to the CDN 140 to deliver a certain experience file to a user device 400 such that an AR experience may be displayed on the user device 400 (e.g., associated with a scanned target, etc.).

Referring now to FIG. 2B, a backend search interface 270 of the remote server 200 is shown according to an exemplary embodiment. The backend search interface 270 is configured to provide a moderator and/or a client with the ability to see various AR experiences, shown by AR experience section 272, uploaded to the AR system 100. The AR experiences presented by the backend search interface 270 may be filtered, based on a search word or phrase, and the like.

Referring now to FIG. 2C, a backend experience interface 280 of the remote server 200 is shown according to an exemplary embodiment. The backend experience interface 280 may provide a more detailed view of the AR experiences presented within the AR experience section 272 of the backend search interface 270. As shown in FIG. 2C, the backend experience interface 280 includes an experience data section 282, a target file section 284, and an experience file section 286. According to an exemplary embodiment, the experience data section 282 includes various data related to an AR experience. The various data may include the UUID associated with the AR experience, the type of AR experience, the validity of the AR experience, and scan information for the AR experience (e.g., a number of times presented to a user, a trendline of scans over time, etc.). According to an exemplary embodiment, the target file section 284 includes all of the target files associated with the AR experience (e.g., may include multiple target files for a single AR experience, etc.). According to an exemplary embodiment, the experience file section 286 includes all of the experience files associated with the AR experience (e.g., experience files for various geofences, experience files for various platforms, etc.).

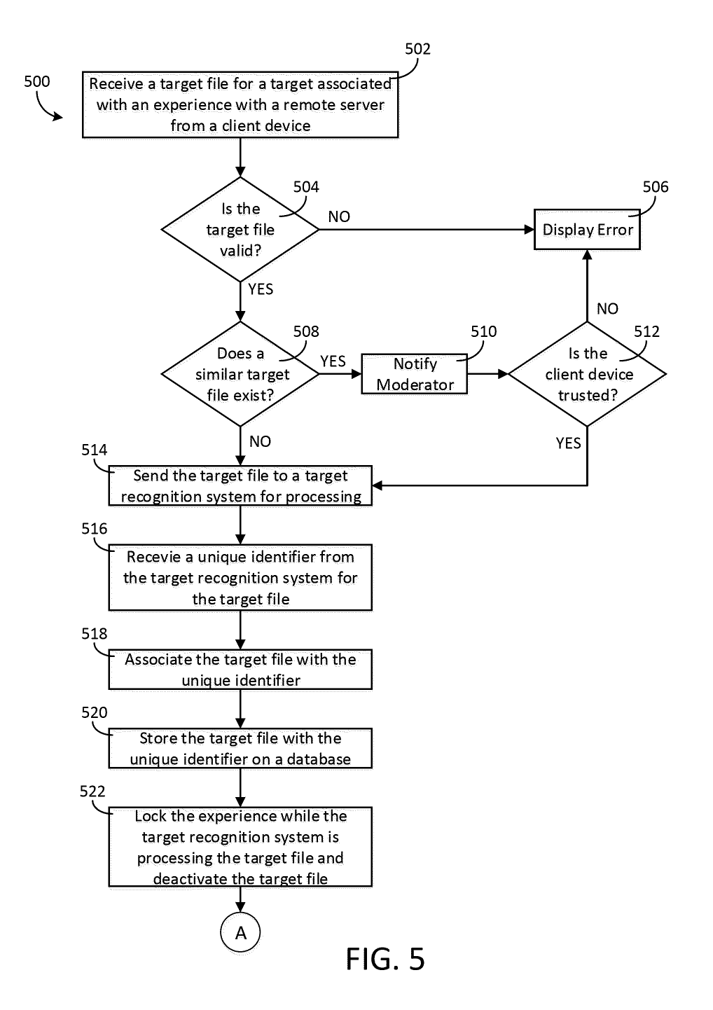

Referring now to FIG. 5, a method 500 for uploading a target file for a target to a remote server is shown according to an exemplary embodiment. In one example embodiment, method 500 may be implemented with the client device 300 and the AR system 100 of FIGS. 1A, 2A, and 3A-3B. Accordingly, method 500 may be described in regard to FIGS. 1A, 2A, and 3A-3B.

At process 502, the remote server 200 is configured to receive a target file for a target associated with an AR experience from the client device 300. In some embodiments, the remote server 200 includes the load balancer 110 to manage communications between client devices 300 and the remote servers 200 (e.g., evenly distribute load between the remote servers 200, etc.). At process 504, the remote server 200 is configured to determine whether the target file is a valid file (e.g., includes an image file, etc.). At process 506, the remote server 200 is configured to command the client device 300 to display an error message on the user interface 310 (i.e., a display) of the client device 300 in response to the target file being invalid (e.g., not including an image file, etc.). At process 508, the remote server 200 is configured to determine whether a similar target file exists in response to the target file being valid (e.g., for brand protection, etc.). In one embodiment, the remote server 200 cross-checks the target file with previously uploaded target files stored in the primary database 130 and/or the replica database 256. In some embodiments, the remote server 200 is configured to send the target file to the target recognition system 120 where the target recognition system 120 compares the received target file to target files previously received to determine whether a similar target file exists.

At process 510, the remote server 200 is configured to notify a moderator of the AR system 100 (e.g., HuntAR Corp., Tagglar Inc., etc.) that a similar target file has been attempted to be uploaded (e.g., an alert, an email, etc.). This may allow the moderator to override any decisions made by the remote server 200 regarding similar target files being uploaded to the AR system 100. At process 512, the remote server 200 is configured to determine whether the client device 300 is a trusted device (e.g., the account the client is using on the client device 300 is verified/registered, etc.) in response to a similar target file existing. If the client device 300 is not trusted, the remote server 200 is configured to deny the upload of the target file and provide a command to the client device 300 to display an error message on the user interface 310 of the client device 300 (process 506).

At process 514, the remote server 200 is configured to send the target file to the target recognition system 120 to be uploaded for further processing in response to at least one of the client device 300 being a trusted device and a similar target not already existing. At process 516, the remote server 200 is configured to receive a unique identifier (e.g., a UUID, etc.) from the target recognition system 120 for the received target file (e.g., while the target file is still being processed by the target recognition system 120, etc.). At process 518, the remote server 200 is configured to associate the target file of the AR experience with the unique identifier (e.g., enters the unique identifier into the metadata of the target file, creates a relationship between the unique identifier, the target file, and the AR experience, etc.). At process 520, the remote server 200 is configured to store the target file with the unique identifier in the primary database 130 (e.g., which may then duplicated and stored within the replica database 256 as a read-only file, etc.). In some embodiments, the remote server 200 only stores the unique identifier for the AR experience (e.g., the target file is not locally stored on the primary database 130 and/or the replica database, etc.). At process 522, the remote server 200 is configured to lock the AR experience associated with the target file and unique identifier while the target recognition system 120 is processing the target file. This may keep data stored within the remote server 200 and the target recognition system 120 consistent (e.g., prevents a client from editing or deleting a target file during processing, etc.). In some embodiments, the remote server 200 is further configured to deactivate the target file while the AR experience is being processed by the target recognition system 120 (e.g., prevents users from scanning a target without a completed AR experience and receiving an incomplete AR experience, etc.).

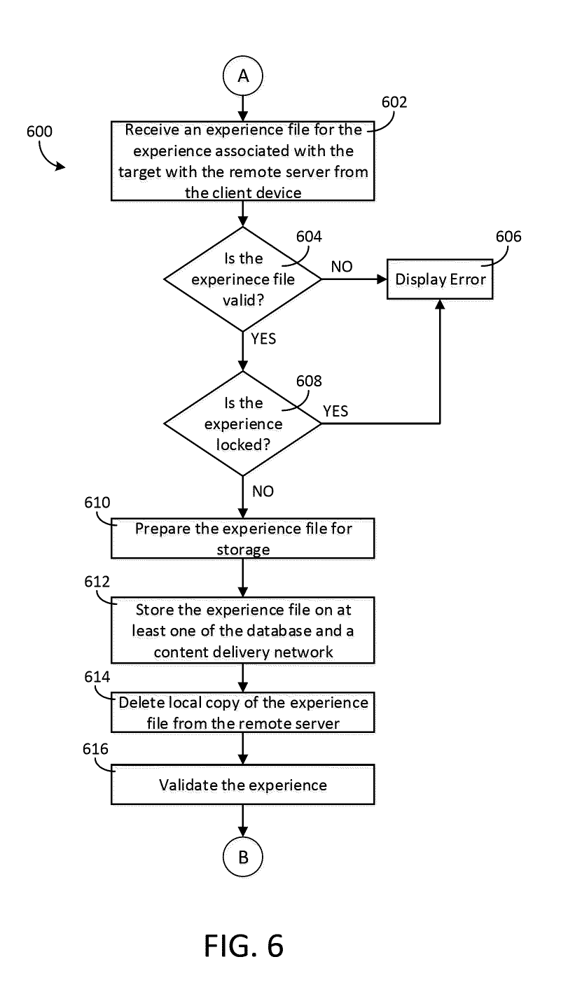

Referring now to FIG. 6, a method 600 for uploading an experience file for a target to a remote server is shown according to an exemplary embodiment. In one example embodiment, method 600 may be implemented with the client device 300 and the AR system 100 of FIGS. 1A, 2A, 3A, and 3c. Accordingly, method 600 may be described in regard to FIGS. 1A, 2A, 3A, and 3C. Method 600 may be a continuation of method 500 as indicated by block A.

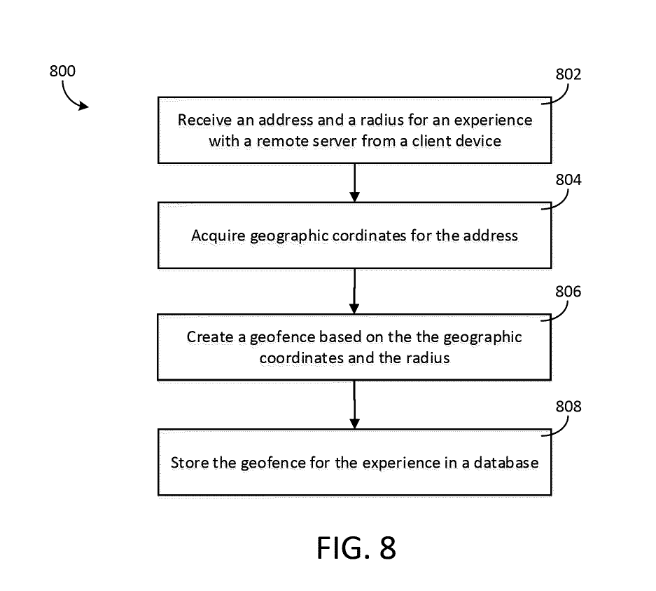

At process 602, the remote server 200 is configured to receive an experience file for the target associated with the AR experience (e.g., that has a target file uploaded and a unique identifier, see method 500, etc.) from the client device 300. In some embodiments, the experience file includes data related to a geofence for the AR experience (see, e.g., FIG. 8). In some embodiments, the remote server 200 is configured to prompt the client whether they would like to attach a geofence to the experience file. At process 604, the remote server 200 is configured to determine whether the experience file is a valid file (e.g., if the client states the experience file is a video the remote server 200 checks that the experience file is in fact a video file, etc.). At process 606, the remote server 200 is configured to provide a command to the client device 300 to display an error message on the user interface 310 of the client device 300 in response to the experience file being invalid (e.g., a .PDF file instead of a video file as indicated, etc.). At process 608, the remote server 200 is configured to determine whether the AR experience associated with the experience file is locked (e.g., whether the associated target file is still being processed by the target recognition system 120, etc.). If the AR experience is locked, the remote server 200 is configured to deny the upload of the experience file and provide a command to the client device 300 to display an error message on the user interface 310 of the client device 300 (process 606).

At process 610, the remote server 200 is configured to prepare the experience file for storage in response to the AR experience being unlocked. Preparing the experience file for storage may include applying a file version number, when the file was uploaded, etc. Therefore, if the experience file is ever edited by the client, the new version is able to overwrite the previous file and the version number is increased (e.g., version 1 to version 2, etc.). At process 612, the remote server 200 is configured to store the experience file on at least one of the primary database 130 (e.g., which may be duplicated onto the replica database 256 as a read-only file, etc.) and the CDN 140. At process 614, the remote server 200 is configured to delete the local copy of the experience file from the remote server 200 (e.g., thereby limiting the necessary storage capability of the remote servers 200, etc.). At process 616, the remote server 200 is configured to validate the AR experience (e.g., activate the target file associated with the experience file, etc.).

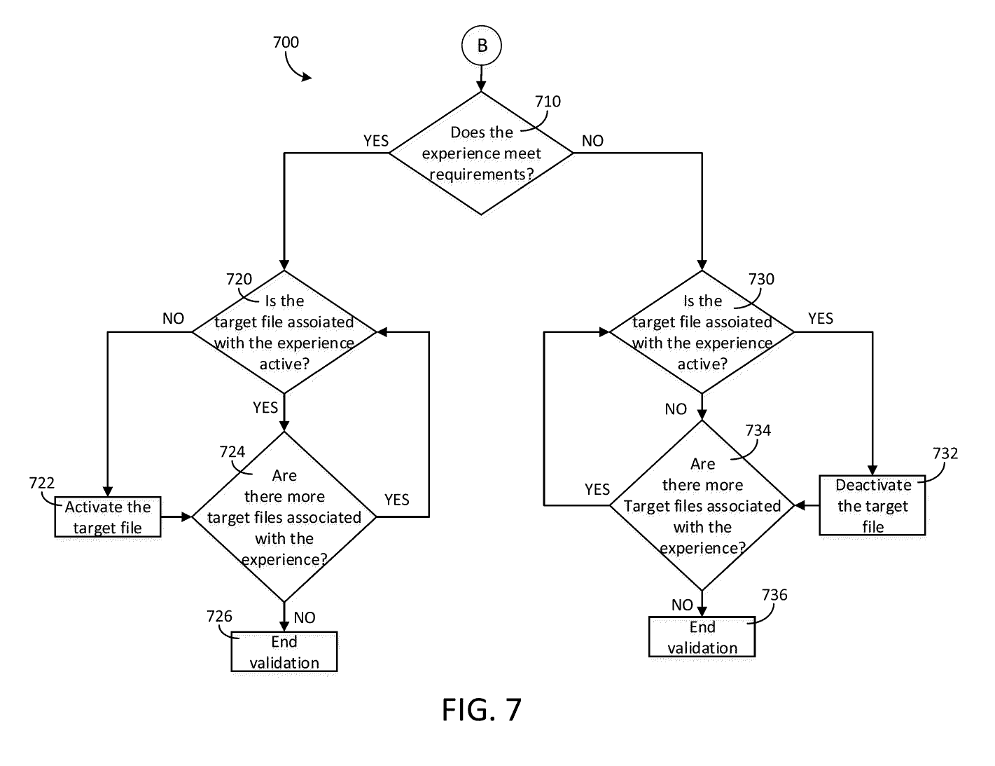

Referring now to FIG. 7, a method 700 for validating an AR experience is shown according to an exemplary embodiment. In one example embodiment, method 700 may be implemented with the client device 300 and the AR system 100 of FIGS. 1A, 2A, and 3A. Accordingly, method 700 may be described in regard to FIGS. 1A, 2A, and 3A. Method 700 may be a continuation of method 500 and/or method 600 as indicated by block B.

At process 710, the remote server 200 is configured to determine whether the AR experience meets all requirements. The validation of the AR experiences may be periodically performed (e.g., hourly, daily, every fifteen minutes, etc.) and/or automatically triggered following a client uploading an experience file to the remote server 200 (see, e.g., FIG. 6). The requirements may include that the AR experience is unlocked, the AR experience includes platform specific experience files (e.g., Apple iOS, Android™, Windows®, etc.), the experience file is valid (e.g., a video file for a video experience, etc.), and/or the like. At process 720, the remote server 200 is configured to determine whether the target file(s) associated with the AR experience is(are) active in response to the AR experience meeting the requirements. At process 722, the remote server 200 is configured to activate the target file associated with the AR experience (e.g., activates the target file on the target recognition system 120, etc.). At process 724, the remote server 200 is configured to determine whether there are more target files associated with the AR experience in response to the target file already being activated (determined at process 720) or the target file being activated (process 722). If there are more target files associated with the AR experience, the remote server 200 is configured to repeat process 720. Otherwise, at process 726, the remote server 200 is configured to end the validation of the AR experience and the AR experience is now ready to be provided to user devices 400 (e.g., in response to an associated target being scanned via a user device 400, etc.).

At process 730, the remote server 200 is configured to determine whether the target file(s) associated with the AR experience is(are) active in response to the AR experience not meeting the requirements (e.g., the AR experience is locked, improves quality of the AR system 100, etc.). At process 732, the remote server 200 is configured to deactivate the target file associated with the AR experience (e.g., deactivates the target file on the target recognition system 120, etc.). At process 734, the remote server 200 is configured to determine whether there are more target files associated with the AR experience in response to the target file already being deactivated (determined at process 730) or the target file being deactivated (process 732). If there are more target files associated with the AR experience, the remote server 200 is configured to repeat process 730. Otherwise, at process 736, the remote server 200 is configured to end the validation of the AR experience and the AR experience is not ready to be provided to user devices 400 (e.g., until the AR experience meets all the requirements, etc.). The validation keeps the target files stored by the target recognition system 120 in sync with the target files stored on the primary database 130 and/or replica database 256.

Referring now to FIG. 8, a method 800 for creating a geofence for an AR experience is shown according to an exemplary embodiment. In one example embodiment, method 800 may be implemented with the client device 300 and the AR system 100 of FIGS. 1A, 2A, 3A, and 3C. Accordingly, method 800 may be described in regard to FIGS. 1A, 2A, 3A, and 3C.

At process 802, the remote server 200 is configured to receive an address and a radius for an AR experience from the client device 300. In some embodiments, the address and the radius are included within an experience file when uploaded by a client. In some embodiments, the remote server 200 is configured to prompt a client regarding adding a geofence to an experience file of an AR experience. At process 804, the remote server 200 is configured to acquire geographic coordinates for the address (e.g., latitude and longitude, etc.). At process 806, the remote server 200 is configured to create a geofence based on the geographic coordinates and the radius (e.g., creating an encircled area of a geographic location, etc.). At process 808, the remote server 200 is configured to store the geofence for the experience file of the AR experience within the primary database 130 (e.g., which may then be duplicated onto the replica database 256, etc.).

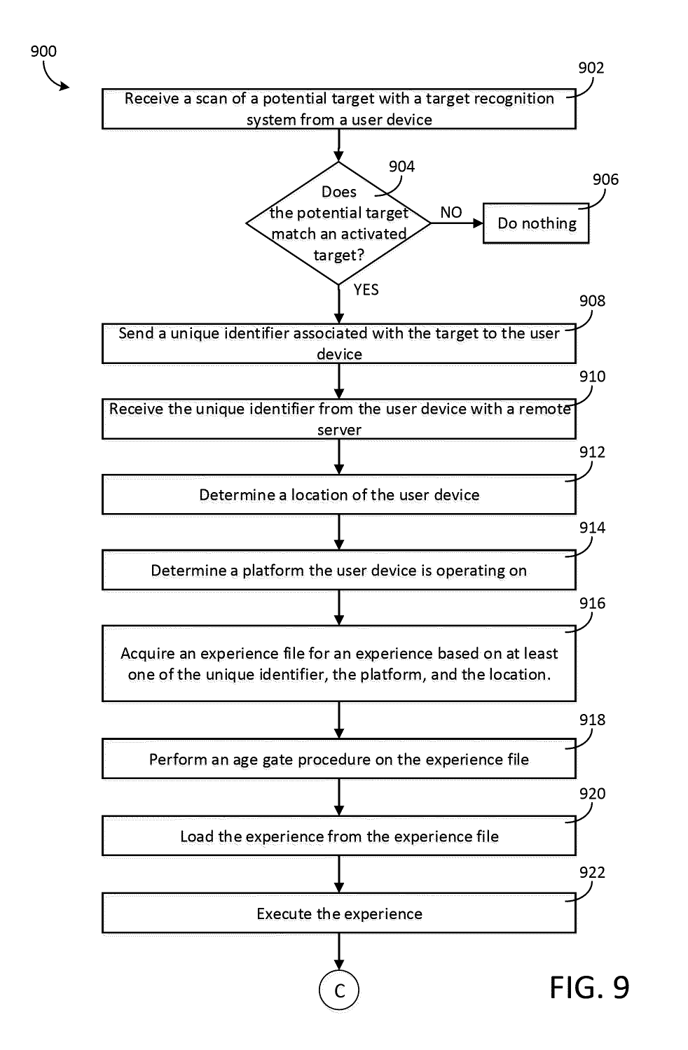

Referring now to FIG. 9, a method 900 for executing an AR experience based on a target scanned by a user device is shown according to an exemplary embodiment. In one example embodiment, method 900 may be implemented with the user device 400 and the AR system 100 of FIGS. 1B, 2A, and 4A-4E. Accordingly, method 900 may be described in regard to FIGS. 1B, 2A, and 4A-4E.

At process 902, the target recognition system 120 is configured to receive a scan of a potential target (e.g., an advertisement, a poster, a bottle, a can, a logo, an insignia, a symbol, a text, a picture, etc.) from the user device 400 (e.g., scanned via the camera device 430, etc.). At process 904, the target recognition system 120 is configured to determine whether the potential target matches a target of an activated target file (e.g., uploaded via the client device 300, see FIGS. 5 and 7, etc.). At process 906, the target recognition system 120 is configured to be unresponsive (i.e., do nothing) in response to the scanned target not matching a target of an activated target file. In other embodiments, the target recognition system 120 is configured to provide a command to the user device 400 that the scanned target does not return any results. At process 908, the target recognition system 120 is configured to send a unique identifier associated with the scanned target to the user device 400 in response to the scanned target matching a target of an activated target file.

At process 910, the remote server 200 is configured to receive the unique identifier from the user device 400. In some embodiments, the remote server 200 is configured to determine a location of the user device 400 (process 912). The location of the user device 400 may facilitate determining whether the user device 400 is within a geofence of an AR experience. In some embodiments, the remote server 200 is configured to determine a platform the user device 400 is operating on (e.g., the operating system of the user device 400, Apple iOS, Android™, Windows®, etc.) (process 914). The platform of the user device 400 may require a platform specific experience file such that the AR experience operates properly on the user device 400. At process 916, the remote server 200 is configured to acquire an experience file for the AR experience from at least one of the primary database 130 and the replica database 256 based on at least one of the unique identifier, the platform of the user device 400, and the location of the user device 400.

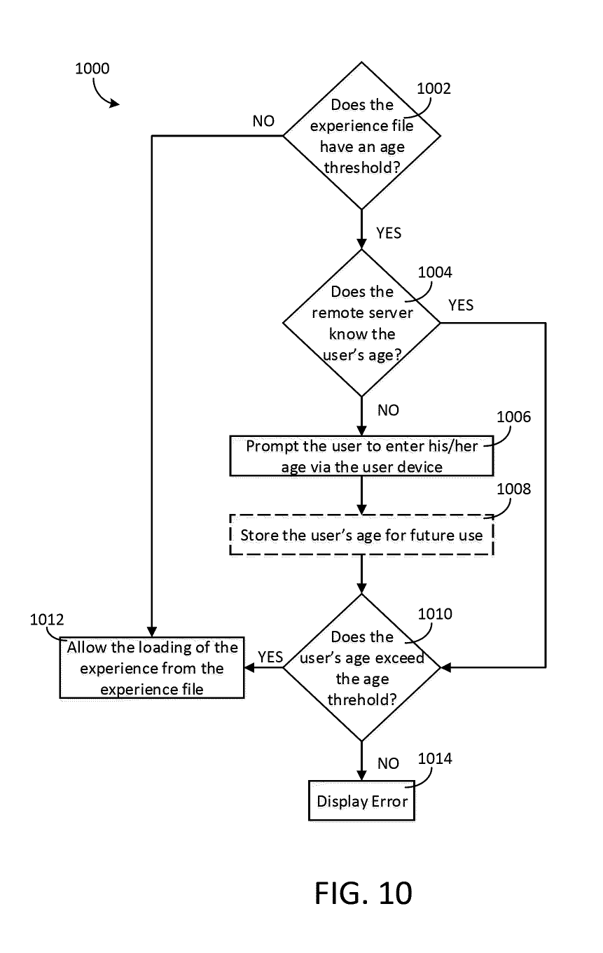

At process 918, the remote server 200 is configured to perform an age gate procedure on the experience file (see, e.g., FIG. 10). At process 920, the remote server 200 is configured to load the AR experience from the experience file onto the user device 400 via the CDN 140 in response to the experience file not having an age threshold or an age of a user of the user device 400 being greater than or equal to the age threshold. At process 922, the remote server 200 is configured to command the user device 400 to execute the AR experience.

Referring now to FIG. 10, a method 1000 for performing an age gate procedure is shown according to an exemplary embodiment. In one example embodiment, method 1000 may be implemented with the user device 400 and the AR system 100 of FIGS. 1B, 2A, 4A, 4C, and 4E. Accordingly, method 1000 may be described in regard to FIGS. 1B, 2A, 4A, 4C, and 4E. According to an exemplary embodiment, method 1000 corresponds to processes 918 and 920 of FIG. 9.

At process 1002, the remote server 200 is configured to determine whether the experience file has an age threshold. At process 1004, the remote server 200 is configured to determine whether the age of the user is known (e.g., stored within the replica database 256, the primary database 130, etc.). At process 1006, the remote server 200 is configured to send a command to the user device 400 to prompt the user to enter his/her age (e.g., birthdate, etc.) in response to the age of the user not being known. In other embodiments, the age of a user is determined when the user first connects to the AR system 100 with the user device 400 (e.g., sets up an account, prompted to enter age, etc.). In some embodiments, the remote server 200 is configured to receive and store the user's age for future use (e.g., such that the user does not have to re-enter his/her birthday each time an AR experience has an age threshold, etc.) (process 1008). In one embodiment, the user's age is associated with an account of the user. In some embodiments, the user's age is associated with the user device 400. Thus, if the user device is lost, damaged, or otherwise unusable by the user, the user would have to re-enter his/her age when using the application of a new device, rather than logging into an account. This may substantially prevent users from editing their age after entering the age information (e.g., to see age inappropriate content, etc.). At process 1010, the remote server 200 is configured to determine whether the user's age is greater than or equal to the age threshold. At process 1012, the remote server 200 is configured allow the loading of an AR experience (e.g., process 920 of FIG. 9) in response to the experience file not having an age threshold (determined at process 1002) or the user's age exceeding the age threshold (determined at process 1010). At process 1014, the remote server 200 is configured to send a command to the user device 400 to display an error message to the user of the user device 400 (e.g., such as “content unavailable” or “age restriction”, etc.) in response to the user's age being less than the age threshold.

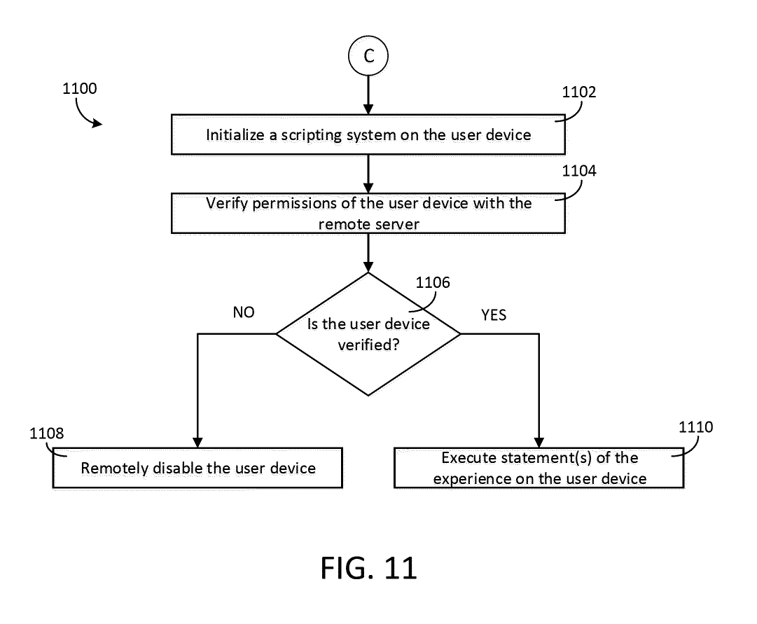

Referring now to FIG. 11, a method 1100 for verifying permissions to display an augmented reality experience on a user device is shown according to an exemplary embodiment. In one example embodiment, method 1100 may be implemented with the user device 400 and the AR system 100 of FIGS. 1B, 2A, and 4A. Accordingly, method 1100 may be described in regard to FIGS. 1B, 2A, and 4A. Method 1100 may be a continuation of method 900 as indicated by block C.

At process 1102, the remote server 200 is configured to provide a command to the user device 400 to initialize a scripting system stored within an application (e.g., the HuntAR application, etc.) on the user device 400. At process 1104, the remote server 200 is configured to communicate with the scripting system of the application on the user device 400 to verify that the user device 400 has permission to communicate with the remote server 200. At process 1106, the remote server 200 is configured to determine whether the user device 400 is verified. At process 1108, the remote server 200 is configured to remotely disable the user device 400 via the scripting system such that the user device 400 cannot access the remote server 200 and the AR experiences in response to the user device 400 not being verified. At process 1110, the remote server 200 is configured to provide a command to the scripting system of the application on the user device 400 to execute the statement(s) of the AR experience such that the AR experience associated with the scanned target is displayed on the user interface 410 of the user device 400.

Referring now to FIG. 12, a method 1200 for providing a video AR experience onto a texture of a target from a remote server is shown according to an exemplary embodiment. In one example embodiment, method 1200 may be implemented with the user device 400 and the AR system 100 of FIGS. 1B, 2A, and 4A-4C. Accordingly, method 1200 may be described in regard to FIGS. 1B, 2A, and 4A-4C. According to an exemplary embodiment, method 1200 is advantageous when applying a video to a texture from a remote location (i.e., the video is not locally stored on the user device 400).

At process 1202, the remote server 200 is configured to acquire a URL for a video or a video file from an experience file based on a target scanned by the user device 400. At process 1204, the remote server 200 is configured to begin streaming the video to the user device 400 (e.g., after the user device 400 has been verified, etc.). At process 1206, the remote server 200 is configured to load the first frame of the video. At process 1208, the remote server 200 is configured to acquire the pixel data from the current frame of the video. At process 1210, the remote server 200 is configured to copy the pixel data to a texture of the target. At process 1212, the remote server 200 is configured to provide a command to the user device to render the frame onto the texture on the target (see, e.g., FIG. 4C). At process 1214, the remote server 200 is configured to determine whether the video is still playing (e.g., the user has not paused the video, etc.) and/or has more frames. If the video is still playing and/or has more frames, the remote server 200 is configured to repeat processes 1206-1212 for each additional frame of the video while the video is playing. If the video is no longer playing or has no more frames, the remote server 200 is configured to end the AR experience being provided to the user via the user device 400 (process 1216).

In an alternative embodiment, an application (e.g., the experience module 464, the processing circuit 450, etc.) associated with the remote server 200 stored of the user device 400 is configured to receive the URL for the video or the video file from the experience file (process 1202) and proceed to perform processes 1204-1216. For example, at process 1204, the application is configured to begin streaming the video on the user device 400. At process 1206, the application is configured to load the first frame of the video. At process 1208, the application is configured to acquire the pixel data from the current frame of the video. At process 1210, the application is configured to copy the pixel data to a texture of the target. At process 1212, the application is configured to render the frame onto the texture on the target (see, e.g., FIG. 4C). At process 1214, the application is configured to determine whether the video is still playing (e.g., the user has not paused the video, etc.) and/or has more frames. If the video is still playing and/or has more frames, the application is configured to repeat processes 1206-1212 for each additional frame of the video while the video is playing. If the video is no longer playing or has no more frames, the application is configured to end the AR experience being provided to the user via the user device 400 (process 1216).

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for providing an augmented reality experience to a user device, comprising:
receiving, by a remote server, a unique identifier from the user device, wherein the unique identifier is indicative of the augmented reality experience;
acquiring, by the remote server, an experience file for the augmented reality experience based on the unique identifier, wherein the experience file includes at least one of the augmented reality experience, a geofence, and an age threshold; and
providing, by the remote server over a content delivery network, the augmented reality experience to the user device for display on a user interface of the user device.

2. The method of claim 1, wherein the user device includes a camera device configured to scan a target, and wherein the user device is configured to send the scan of the target to a target recognition system.

3. The method of claim 2, wherein the target recognition system is configured to compare the scan of the target to targets stored within the target recognition system, and transmit the unique identifier for the target to the user device in response to the target matching one of the targets stored within the target recognition system.

4. The method of claim 2, wherein the augmented reality experience is at least one of displayed over the target, along a surface of the target, and in a new window.

5. The method of claim 1, wherein the augmented reality experience includes at least one of a two-dimensional image, a three-dimensional image, a two-dimensional animation, a three-dimensional animation, game logic, a video, a video applied to a texture, text, music, tactile feedback, and interactive content.

6. The method of claim 1, further comprising determining, by the remote server, a location of the user device, wherein acquiring the experience file is further based on the location of the user device being within the geofence of the experience file.

7. The method of claim 1, further comprising determining, by the remote server, a platform the user device is operating on, wherein acquiring the experience file is further based on the platform of the user device such that a platform specific augmented reality experience is acquired.

8. The method of claim 1, further comprising comparing, by the remote server, the age threshold of the experience file to an age of a user of the user device, wherein providing the augmented reality experience to the user device is based on the age of the user being greater than or equal to the age threshold.

9. The method of claim 8, further comprising:
acquiring, by the remote server, the age of the user of the user device in response to the experience file including the age threshold and the remote server not knowing the age of the user; and
storing, by the remote server, the age of the user in response to the age of the user not already being stored by the remote server.

10. A method for creating an augmented reality experience for display on a user device, comprising:
receiving, by a remote server, a target file for a target from a client device, wherein the target file includes an image of the target;
determining, by the remote server, at least one of the client device is a trusted device and a similar target file does not already exist;
acquiring, by the remote server, a unique identifier from a target recognition system for the target of the target file in response to a similar target file not existing or a similar target file existing but the client device is a trusted device;
receiving, by the remote server, an experience file for the target from the client device, wherein the experience file includes the augmented reality experience; and
storing, by the remote server, the experience file and the unique identifier associated with the target on a database.

11. The method of claim 10, wherein the augmented reality experience includes at least one of a two-dimensional image, a three-dimensional image, a two-dimensional animation, a three-dimensional animation, game logic, a video, a video applied to a texture, text, music, tactile feedback, and interactive content.

12. The method of claim 10, further comprising validating, by the remote server, the target file, wherein validating the target file includes determining that the target file includes the image of the target.

13. The method of claim 10, wherein the target recognition system is configured to process and store the target file.

14. The method of claim 13, further comprising locking, by the remote server, the augmented reality experience while the target file is being processed by the target recognition system.

15. The method of claim 14, further comprising validating, by the remote server, the augmented reality experience, wherein validating the augmented reality experience includes determining at least one of (i) the experience file is in a desired format, (ii) the augmented reality experience is unlocked, and (iii) the experience file includes platform specific experience files for various operating platforms of user devices.

16. The method of claim 15, further comprising deactivating, by the remote server, the target file within the target recognition system while the augmented reality experience is invalid such that the augmented reality experience associated with the target file is not provided to the user device in response to the user device scanning the target associated with the target file.

17. The method of claim 10, wherein the database is external from the remote server, and wherein a read-only copy of the experience file is stored locally on the remote server.

18. The method of claim 10, wherein the remote server is capable of providing the augmented reality experience from the experience file to the user device in response to the user device scanning the target associated with the unique identifier.

19. A method for providing a video augmented reality experience onto a texture of a target from a remote server, comprising:
loading, by the remote server, a frame from a video of the video augmented reality experience;
acquiring, by the remote server, pixel data from the frame of the video;
copying, by the remote server, the pixel data to the texture of the target; and
providing, by the remote server, a command to the user device to render the frame of the video onto the texture of the target;
wherein the remote server is configured to repeat the acquiring, the copying, and the providing steps for each additional frame of the video while the video is playing on the user device, and wherein the video is not stored locally on the user device.

20. The method of claim 19, further comprising:
loading, by an experience module on the user device associated with the remote server, each frame of the video on an frame-by-frame basis; and
rendering, by the experience module for display to a user of the user device, each frame of the video onto the texture of the target such that each subsequent frame is over-laid over the prior frame to provide a representation of the video on the texture.
